(19) United States
(12) Patent Application Publication
(10) Pub. No.: US 2009/0228868 A1
(43) Pub. Date: Sep. 10, 2009

(54) BATCH CONFIGURATION OF MULTIPLE TARGET DEVICES

(76) Inventors: Max Drukman, San Francisco, CA (US); Matthew Firlik, Cupertino, CA (US); Andreas Wendker, Mountain View, CA (US); Scott Forstall, Mountain View, CA (US)

Correspondence Address: Knobbe, Martens, Olson & Bear, LLP, 2040 Main Street, Fourteenth Floor, Irvine, CA, 92614, US

(21) Appl. No.: 12/133,294

(22) Filed: Jun. 4, 2008

Related U.S. Application Data
(60) Provisional application No. 61/033,762, filed on Mar. 4, 2008.

(51) Int. Cl. G06F 9/44

(52) U.S. Cl. 717/121

(57) ABSTRACT

Multiple target devices, such as wireless phones, may receive configuration data, such as software updates, configuration settings, developer environment settings, etc., from a host computer that automatically detects characteristics of respective target devices and selects the appropriate configuration data. A configuration process may generally include identifying the target devices, determining characteristics of the target devices, such as device type, device storage capacity, operating system, operating system version, installed software, etc., and selecting configuration data for updating the target devices for communication with the host computer. Configuration data may include data that: allows the target device to establish an appropriate development environment with a developer computing device, such as settings and/or software for debugging, performance analysis, and/or software execution monitoring; indicates changes to the configuration and/or registry settings of a target device; configures, adds, updates, or removes software; updates operating system components; and/or personalizes and/or adds user interface components, for example.

### REFERENCE TO RELATED APPLICATIONS

The present application claims priority to U.S. Provisional Application No. 61/033,762, filed Mar. 4, 2008, and entitled BATCH CONFIGURATION OF MULTIPLE TARGET DEVICES, the entire contents of which is hereby incorporated by reference in its entirety and should be considered a part of this specification.

### BACKGROUND

1. Field

This disclosure relates to configuring a host device for communication with each of a plurality of mobile devices.

2. Description of the Related Technology

Mobile phones may be configured and operated using one or more of several voice and/or data communication protocols. For example, wireless voice communications in the U.S. and worldwide are available using communication protocols including code division multiple access (CDMA), Global System for Mobile communications (GSM), Universal Mobile Telecommunications System (UMTS), Generic Access Network (GAN), Integrated Digital Enhanced Network (iDEN), and other communication protocols. In addition to these various voice communication protocols, carriers often use different communication protocols for wireless transmission of data, such as CDMA2000, Evolution-Data Optimized (EV-DO), High-Speed Packet Access (HSPA), and Worldwide Interoperability for Microwave Access (WiMAX), for example. In order for a mobile phone to operate properly on a particular carrier's network, the mobile phone must execute software that is configured to transmit and receive voice and/or data signals using the carrier's selected communication protocol. Not only does the operating system (OS) software on the mobile device need to operate according to the particular carrier's communication protocol, but other software applications that provide wireless voice and/or data services must also be configured to operate according to the particular carrier's selected communication protocol.

A software development kit (SDK) is a set of development tools that allows a software developer to create applications for a certain software package, software framework, and/or hardware platform. For example, a SDK may be installed on a computing device of a system administrator or software developer (referred to herein generally as a “configuration device”) for writing code that is to be executed on another device, such as a mobile phone, MP3 player, game console, or other electronic device (referred to generally as “target devices” or “targets”). For each target device, system level data communication with the configuration device often requires configuration settings that may be different for each target device, the configuration device, and/or the SDK. For example, each development environment may require that different capabilities are enabled on the target device, such as debugging, performance analysis, and/or quality assurance monitoring capabilities. Thus, when a developer is developing software for use on multiple target devices, the developer may be required to reconfigure the SDK settings, as well as configuration settings of each target phone that may be sequentially tethered to the configuration device, before a desired development environment may be established.

### BRIEF DESCRIPTION OF THE DRAWINGS

FIG. 1A is a block diagram illustrating one embodiment of a configuration device tethered to a first target device via a direct wired link.

FIG. 1B is a block diagram illustrating a second target device that is indirectly tethered to the configuration device via a network.

FIG. 2 is a block diagram illustrating one embodiment of an exemplary configuration device that is configured to automate configuration of multiple mobile devices.

FIG. 3 is a block diagram illustrating one embodiment of a configuration device in communication with multiple target devices.

FIG. 4 is a flowchart illustrating one embodiment of a method of batch configuration of a plurality of target devices.

FIG. 5 is a flowchart illustrating another embodiment of a method of batch configuration of a plurality of target devices.

FIG. 6 illustrates an exemplary user interface of the configuration utility of FIG. 2 that provides information regarding each of a plurality of target devices that have been tethered to a host computer.

FIG. 25A illustrates an example embodiment of a mobile device.

FIG. 25B illustrates an example embodiment of a configurable top-level graphical user interface of a mobile device.

FIG. 30 is a block diagram of an example implementation of a mobile device.

### DETAILED DESCRIPTION

Embodiments of the present disclosure allow multiple target devices, such as wireless phones, to receive configuration data, such as target device configuration settings, application data, provisioning profiles, VPN settings, and/or other data that is useful and/or necessary for proper operation and/or communication of the target devices. In one embodiment, the configuration data is transmitted to respective target devices from a host computer that is configured to perform a batch configuration of the multiple target devices. In one embodiment, a configuration process can be automatically performed for each of the target devices as they are concurrently and/or sequentially tethered to the host computer.

In one embodiment, the configuration process may include identifying the target devices, determining characteristics of the target devices, such as software development capabilities and software versions, and selecting configuration data for transmission to the target devices. In one embodiment, the configuration data allows the configuration device, or another developer device, to properly communicate with the target devices via a SDK. Depending on the embodiment, configuration data may include data for communicating with a SDK on the host computer, such as debugging, performance analysis, and/or execution monitoring capabilities, for example; changing the configuration and/or registry settings of a target device; configuring, adding, updating, or removing software; updating operating system components; personalizing and/or adding user interface components; activating software available in ROM or installed over the air; and/or any other data that may be executed, stored, or otherwise used by a target device.

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

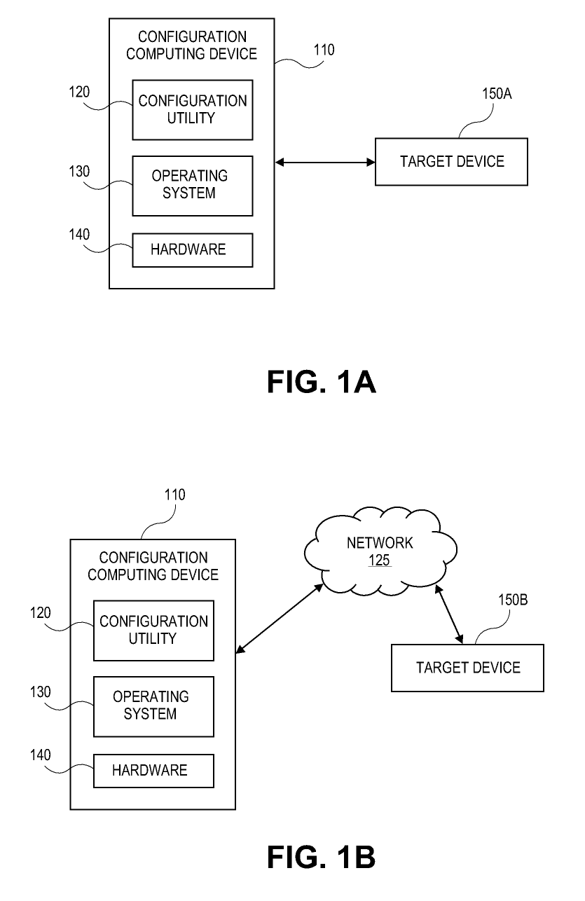

FIG. 1A is a block diagram illustrating one embodiment of configuration device 110 tethered to first target device 150A via a direct wired link. The term “tether,” and derivatives thereof, generally describe a connection between two electronic devices, such as a computer and a target device or between two target devices, for example. In general, tethering can occur via a directly wired connection between the devices, such as via a USB, IEEE 1394, or other communication cable, or via one or more wireless connections, such as via a Bluetooth or WAN connection between the devices. In the embodiment of FIG. 1A, target device 150A may be directly tethered to the configuration device, either through a wired or a wireless communication link.

FIG. 1B is a block diagram illustrating second target device 150B that may be indirectly tethered to configuration device 110 via network 125, which may include one or more communication networks, such as LANs, MANs, WANs, and/or the Internet. FIGS. 1A and 1B, as well as the remainder of the figures herein, discuss target devices 150, which include an unlimited quantity and types of target devices, including specific target devices 150A, 150B, 150C, 150N that are discussed herein.

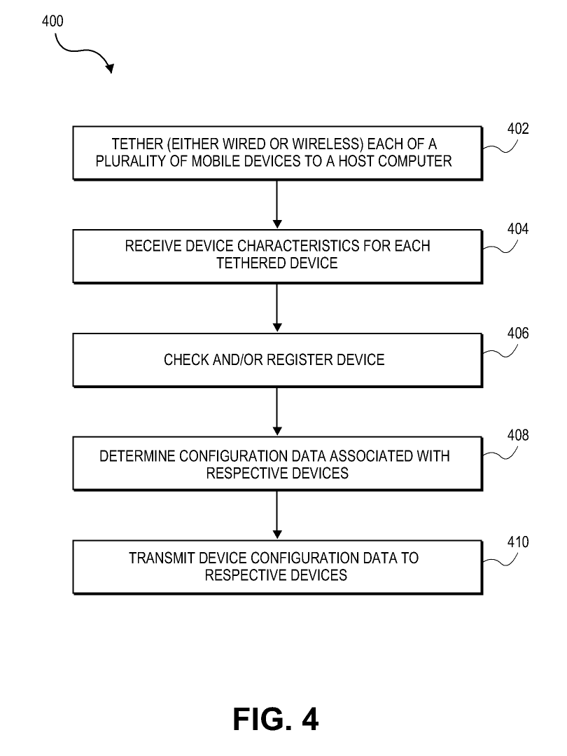

In the embodiment of FIGS. 1A and 1B, configuration device 110 is illustrated having only a few of the components and/or modules that configuration device 110 may include. FIG. 4, which is described in further detail below, provides further exemplary description of components and/or modules that may be included in configuration device 110. Exemplary configuration device 110 of FIGS. 1A, 1B, includes hardware 140, such as a motherboard, processor, memory, peripheral devices, etc., that are included in a typical computing device. Configuration device 110 also includes an operating system, such as OS X, Windows 95, 98, NT, 2000, XP, Vista, Linux, SunOS, Solaris, PalmOS, Blackberry OS, or other proprietary or open source operating systems. Target devices 150A and 150B, as well as other target devices 150 illustrated in other Figures, include electronic devices with a code processor that may be configured to execute software code that may be preloaded on target device 150 and/or may be uploaded via a communication link with configuration device 110 or other programming devices. For example, target devices 150 may include a mobile phone, a MP3 player, or a game console, for example. In one embodiment, target devices 150 can be Apple iPhones and/or iPods, for example.

In the embodiments of FIGS. 1A and 1B, target devices 150 may undertake a configuration process with configuration device 110 in order to receive configuration data from configuration device 110. As used herein, the term “configuration” describes a process of a target device providing one or more device characteristics to a configuration device and, in return, receiving configuration data that may be used by the target device. As noted above, configuration data for a target device may include, among other data, new software and/or software updates for the target device and/or information indicating adjustments to software development parameters and/or rights of the target device, for example. In one embodiment, configuration data includes code that may be executed on the target device in order to install software that aids communication with the configuration device and/or a SDK executing on a developer computing device. In one embodiment, the configuration data may include other software code, such as software code that enhances the operations of the particular target device. For example, configuration data may include code for changing the configuration and/or registry settings of a target device, configuring, adding, updating, or removing software, updating operating system components, personalizing and/or adding user interface components, and/or activating software available in ROM or installed over the air.

In one embodiment, configuration of one or more target devices may be performed manually, such as by an administrator responsible for updating each of the one or more target devices, wherein the configuration data for each of the tethered target devices may be selected by the administrator and transmitted to the target devices. As described in further detail below, in an advantageous embodiment, the configuration process may be automated and multiple target devices may be concurrently configured with a single configuration device, wherein depending on certain characteristics of respective target devices, the configuration data transmitted to the respective target devices may be customized.

In one embodiment, after target devices 150A, 150B are tethered to configuration device 110 (such as is illustrated in FIGS. 1A, 1B), a configuration process begins by target devices 150A, 150B transmitting device characteristics to configuration device 110. In one embodiment, device characteristics may include a device type, a unique data item description (UDID), such as a device serial number, e.g., an ESN of a mobile phone, a nickname for a target device, a device storage capacity, an installed OS, or any other data associated with a particular target device 150. In one embodiment, configuration of target devices 150A, 150B may require them to provide additional device characteristics, such as wireless carrier information, communication protocols, indications of installed software, and/or other device configuration information. In one embodiment, configuration device 110 maintains the received device characteristics for target devices 150 that have been previously tethered to configuration device 110. In one embodiment, subsequent configurations of a target device that has been previously configured by configuration device 110 initiates retrieval of the stored device characteristics that were previously provided to configuration device 110. Based on the device characteristics, and possibly other information regarding the tethered target device 150, configuration device 110 can select and provide appropriate configuration data for each respective target device 150.

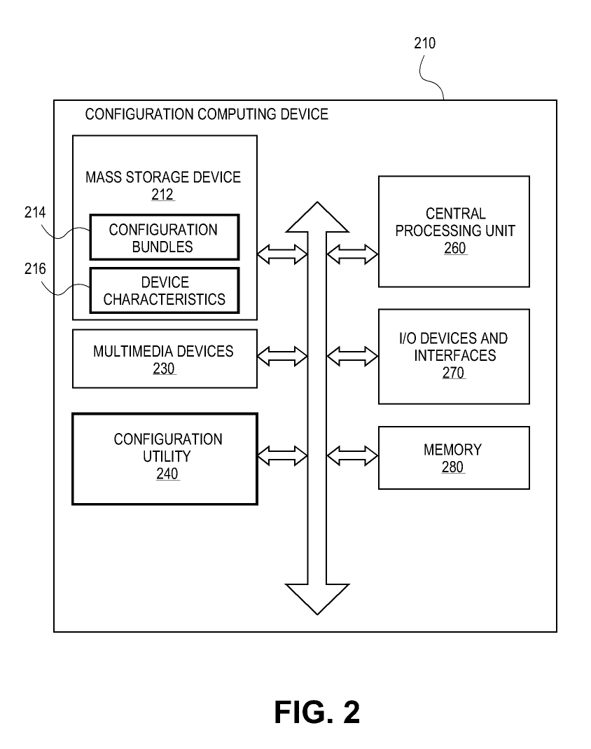

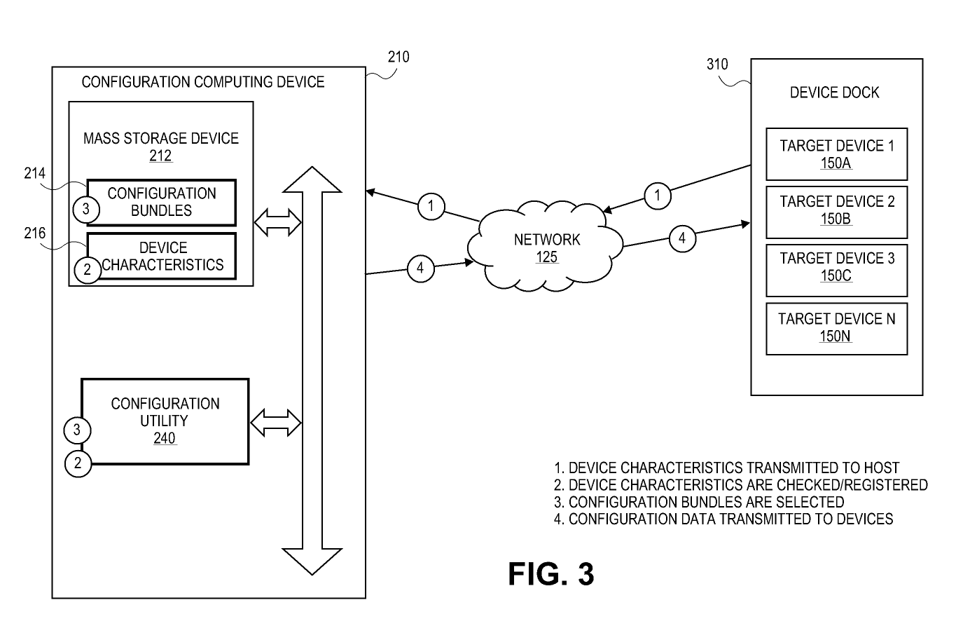

FIG. 2 is a block diagram illustrating one embodiment of exemplary configuration device 210 that may be configured to automate configuration of multiple target devices so that the devices have current software and device settings and so an administrator, software developer, or other individual or group responsible for providing content to multiple devices can easily access each of the registered mobile devices, such as via a SDK of a developer computer. As described in further detail below, multiple target devices 150 may concurrently receive respective configuration data from the configuration device 210 and/or target devices 150 may sequentially receive respective configuration data as they are sequentially tethered to configuration device 210. FIGS. 3-5, which are described in further detail below, illustrate exemplary processes of selecting appropriate configuration data for each of a plurality of target devices and providing the respective configuration data to multiple target devices 150. The functionality provided for in the components and modules of configuration device 210 may be combined into fewer components and modules or further separated into additional components and modules.

In one embodiment, configuration device 210 includes, for example, a server or a personal computer that executes a Mac OS, such as OS X. In other embodiments, however, configuration device 210 may execute a Windows or Linux/Unix OS, or may operate using one or more of multiple available proprietary and open-source operating systems. In one embodiment, exemplary configuration device 210 includes central processing unit (“CPU”) 260, which may include one or more conventional microprocessors. Configuration device 210 may further include memory 280, such as random access memory (“RAM”) for temporary storage of information, a read only memory (“ROM”) for permanent storage of information, and mass storage device 212, such as one or more hard drives, diskettes, and/or optical media storage devices. In certain embodiments, mass storage device 212 stores device characteristic information 212 and/or device configuration bundles 216. As described in further detail below, in one embodiment device characteristics of specific target devices may be used to select one or more configuration bundles for transmission to the respective target devices, such that each target device may receive configuration data that is customized for that particular target device. Typically, the modules of configuration device 210 are in communication with one another via a standards based bus system. In different embodiments, the standards based bus system could be Peripheral Component Interconnect (PCI), Microchannel, SCSI, Industrial Standard Architecture (ISA) and Extended ISA (EISA) architectures, for example.

Configuration device 210 includes one or more commonly available input/output (I/O) interfaces and devices 270, such as a keyboard, mouse, touchpad, and printer. In one embodiment, I/O devices and interfaces 270 include one or more display device, such as a monitor, that allows the visual presentation of data to a user. More particularly, a display device provides for the presentation of GUIs, application software data (such as user interfaces associated with configuration utility 240), and multimedia presentations, for example. The configuration device 210 may also include one or more multimedia devices 230, such as speakers, video cards, graphics accelerators, and microphones, for example. In one embodiment, I/O interfaces and devices 270 includes devices that are in communication with modules of the configuration device 210 via a network, such as one or more wired and/or wireless local area networks, for example.

In the embodiment of FIG. 2, configuration device 210 also includes application modules that may be executed by the CPU 260. More particularly, the application modules include configuration utility 240, which is configured to receive device characteristics of respective target devices, select one or more configuration bundles 214 (or simply “bundles”) for the target devices, based at least partly on the respective device characteristics, and transmit the selected configuration data (e.g., comprising one or more configuration bundles) to respective target devices. Configuration bundles, as used herein, comprise configuration data, where each configuration bundle may comprises different configuration data. For example, a first configuration bundle may includes multiple software applications that utilize a built-in camera of a particular model mobile phone, a second configuration bundle may include an OS update for certain OS versions, and a third configuration bundle may include software development parameters for a particular subset of target devices. In certain embodiments, configuration utility 240 may be configured to receive data from target devices 150, such as application logs, data file backups, etc. For example, in one embodiment configuration utility 240 performs a backup of certain data stored on at least some target devices 150, storing the backup data on mass storage device 212, for example. Thus, in certain embodiments data flow is bidirectional between target devices 150 and configuration device 210.

In one embodiment, configuration utility 240 is included in application software, such as Apple's Phone Booth, and/or as part of an integrated development environment, such as Apple's Xcode software development application. In other embodiments, configuration utility 240 may be included in any other software development application that may be suitable for developing software code for one or more mobile devices 150. In an advantageous embodiment, configuration utility 240 may be installed on a host computer in order to configure the host computer to serve as a provisioning “kiosk” (or configuration device) in selecting and providing configuration data to each of a plurality of target devices 150, wherein the configuration data for target devices is automatically selected based on device characteristics of the respective target devices.

FIG. 3 is a block diagram illustrating one embodiment of configuration device 210 in communication with multiple target devices 150, including target devices 150A, 150B, 150C, 150N, via network 125. In the embodiment of FIG. 3, target devices 150 are each cradled to device dock 310, which may include a hardware platform that physically engages target devices 150 so that one or more communication ports of the cradled target devices 150 are in physical contact with communication ports of device dock 310. In one embodiment, one or more target devices 150 can be cradled with device dock 310 via a wireless communication link. Device dock 310, in turn, may be in communication with configuration device 210 via network 125, which includes one or more of any available networks, including the Internet, for example. In FIG. 3, an exemplary flow of data between configuration device 210 and target devices 150 is illustrated by circled numerals. In other embodiments, the flow of data may include fewer or additional steps and the steps may be performed in a different order than is illustrated and discussed with reference to FIG. 3.

In step 1 of FIG. 3, target devices 150 that are cradled with device dock 310 transmit one or more device characteristics to configuration device 210. Depending on the embodiment, the device characteristics may include various levels of information regarding the corresponding target device. In one embodiment, device characteristics include UDIDs, such as ESNs of mobile telephones, while in other embodiments device IDs include nicknames that have been assigned to respective target devices, such as by respective users of the target devices. In one embodiment, for a target device that has previously received configuration data from configuration device 210, certain device characteristics may be retrieved from the device characteristics data 216 stored by the configuration device 210.

In step 2 of FIG. 3, configuration utility 240 of configuration device 210 receives the device characteristics from target devices 150 and continues with the configuration process. In one embodiment, device characteristics 216, which may be stored in mass storage device 212, include a data structure associating one or more device characteristics, such as UDIDs, with other device characteristics. In one embodiment, the initial configuration of a target device 150 with configuration device 210 includes the transfer of additional device information to configuration device 210, which may be then stored as device characteristics 216. Subsequent configurations of the target device may be performed with only the transmission of the device UDIDs, for example, as the additional device characteristics may be already stored in the device configuration information 216. In one embodiment a target device must register with configuration device 210 before configuration device 210 can exchange information, such as software code, with the target device. Similarly, configuration device 210 may be configured to only interface with a predetermined group of target devices, such as those having UDIDs and/or device types indicated in a list compiled by an administrator. In this embodiment, if a target device does not fall within the predetermined group, configuration of the target device will fail and communication between configuration device 210 will cease.

After receiving device characteristics from target devices 150 and/or from the device characteristics 216, in step 3 of FIG. 3 configuration utility 240 determines configuration data, e.g., comprising zero or more configuration bundles, for each cradled target device 150. In one embodiment, configuration utility 240 comprises, and/or has access to, a data structure indicating configuration bundles 214 that are associated with respective device characteristics. Thus, configuration bundles 214 for each of a plurality of target devices having various device types, operating systems, operating system versions, software development software, voice and data carriers, voice and data communication protocols, and/or other device characteristics, may be appropriately selected by configuration utility 240. For example, each target device 150A, 150B, 150C, 15ON may be an iPhone, with target device 150A iPhone having a first set of software development capabilities, while target device 150B has a second set of software development capabilities, and target device 150C has a third set of software development capabilities. Accordingly, in order to establish a suitable software development environment with each of target devices 150A, 150B, 150C, configuration device 210 may select different configuration bundles 214, e.g., each including different software development software and settings, for each of target devices 150A, 150B, 150C. In one embodiment, target devices 150A, 150B, 150C may each include different installed software, such as system, utility, multimedia, and/or entertainment software. In this embodiment, the configuration bundles 214 selected for respective devices 150A, 150B, 150C may include different software applications for installation on the target devices. In one embodiment, one or more software bundles may be selected for a target device based on the type of device and/or specific UDID of the device, for example. For example, a first configuration bundle may be selected for all iPhones while a different second configuration bundle may be selected for all iPods.

In step 4 of FIG. 3, the configuration data for target devices 150 may be transmitted to the respective target devices, such as via network 125 and/or device dock 310. For example, first configuration data may be transmitted to target device 150A, while second configuration data may be transmitted to target device 150B. In other embodiments, a configuration file including configuration data for multiple target devices 150 may be transmitted to device dock 310, which then supplies the appropriate configuration data for each individual target device 150.

Target devices 150 may execute any software code that has been provided by configuration device 210, adjust any device settings indicated in the configuration data, and perform any other operations indicated in their respective configuration data. In one embodiment, after processing received configuration data, target devices 150 are configured to communicate with an IDE for development, modification, and/or debugging of software code on target devices 150. In one embodiment, users of respective target devices selectively and periodically tether their devices to configuration device 210 in order to receive any useful and/or necessary configuration data for their target device. In this way, an organization can provide updated configuration data to each of a plurality of target devices, where each target device and/or groups of target devices may receive different configuration data. In one embodiment, configuration utility 240 includes a user interface that displays a listing of each of devices 150 that are currently tethered to configuration device 210, such as a listing of UDIDs associated with each of devices 150, and allows an administrator to monitor the configuration of devices 150.

FIG. 4 is a flowchart 400 illustrating one embodiment of a method of batch configuring a plurality of target devices. Depending on the embodiment, the method of FIG. 4 may include fewer or additional blocks and blocks may be performed in an order that may be different than illustrated.

Beginning in block 402, each of a plurality of mobile devices may be tethered to a host computer, such as configuration device 110, 210. In one embodiment, each of the mobile devices may be tethered to the host computer via a physical bay of device cradles, such as device dock 310 of FIG. 3. In one embodiment, at least some of the mobile devices are tethered directly to the host computer, such as via USB or IEEE 1394 cables. In one embodiment, at least some of the mobile devices are tethered wirelessly either to a remote cradle, such as device dock 310 of FIG. 3, or directly to the host computer. Thus, depending on the embodiment, the individual mobile devices may be tethered to the host computer in various manners.

Moving to block 404, the host computer receives device characteristics, such as UDIDs, for each of the tethered devices. In one embodiment, device UDIDs can include nicknames that are given to respective mobile devices, such as “Mark's phone,” “work,” and “Lisa's iPhone,” serial numbers, or any other series of characters.

Continuing to block 406, the host computer checks the received device characteristics, such as the device UDID, against a listing of device characteristics corresponding to devices that are authorized to receive configuration data from the configuration device. For example, an administrator may establish relationships between target devices having one or more specific device characteristics and configuration bundles that should be transmitted to those target devices. In one embodiment, the administrator may allow only target devices having UDIDs in a predetermined UDID list (e.g., corresponding with devices for which the administrator is responsible) to receive configuration data. If a particular target device has not previously registered with the host computer, the host computer may be configured to automatically register the target device. In one embodiment, no further information from the target device may be required to register with the host computer. In other embodiments, appropriate authorization credentials and/or additional device characteristics may be required by the host computer prior to registering a target device.

Next, in block 408 the host computer determines configuration data, e.g., comprising zero or more configuration bundles, for respective tethered target devices. As noted above, configuration utility 240 may be configured to select different sets of configuration bundles 214 for target devices with different hardware specifications, software operating systems, software applications, development capabilities, etc. Likewise, configuration utility 240 may be configured to select different sets of configuration bundles 214 for target devices based on rights associated with the respective target device, such as might be determined by a system administrator. Accordingly, based on the device UDID and any other relevant device characteristics, such as a wireless carrier associated with the device, the host computer determines what configuration data to transmit to respective target devices.

In block 410, the configuration data for each of the tethered target devices may be transmitted to the target devices. In one embodiment, the configuration data allows the target devices to establish an open communication channel with a software developer such that data communications between the host computer and target devices may be simplified. In one embodiment, the configuration data transmitted to respective target devices is selected to provide the respective user of the target devices with the software capabilities that are necessary for the user's needs. Thus, a first iphone with a first UDID may be provided with a first configuration bundle having a set of mobile telephone software applications and a second configuration bundle having VPN settings, while a second iPhone with a second UDID may only be provided with the second configuration bundle.

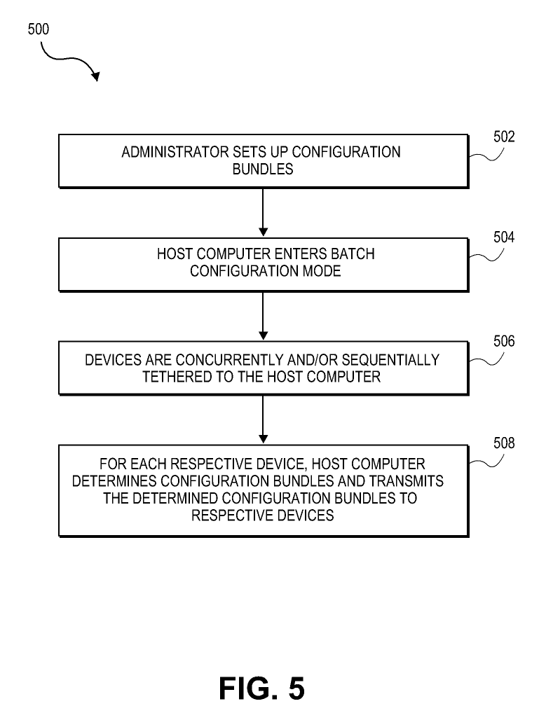

FIG. 5 is a flowchart 500 illustrating another embodiment of a method of batch configuration of a plurality of target devices. In the embodiment of FIG. 5, a computing device is configured as a batch provisioning device for providing configuration data to each of a plurality of target devices. Depending on the embodiment, the method of FIG. 5 may include fewer or additional blocks and blocks may be performed in an order that may be different than illustrated.

Beginning in block 510, an administrator sets up one or more configuration bundles, each including configuration data. As noted above, configuration data may include data that: allows the target device to establish an appropriate development environment with a developer computing device, such as settings and/or software for debugging, performance analysis, and/or software execution monitoring, for example; indicates changes to the configuration and/or registry settings of a target device; configures, adds, updates, and/or removes software; updates operating system components; personalizes and/or adds user interface components; activates software available in ROM or installed over the air; and/or provides any other data that may be executed, stored, or otherwise used by, for example, a target device.

In one embodiment, the administrator establishes associations between respective data bundles and one or more device characteristics. In one embodiment, a configuration data structure indicates the associations between device characteristics and respective configuration bundles. Additionally, the configuration data structure may indicate the particular configuration data associated with respective configuration bundles. Depending on the embodiment, a configuration bundle may comprise a single configuration data, such as a single software application or device setting, or multiple configuration data, such as multiple software applications and/or device settings.

In one embodiment, the data bundle associations indicate one or more configuration bundles that are associated with all target devices, such that all devices that tether to the host computer in batch mode receive the same content, regardless of the specific device characteristics. In one embodiment, the data bundle associations may use device characteristics in order to determine the specific content available and/or necessary for pushing to a particular target device. The device characteristics associated with data bundles could be device UDIDs (and associated provisions), device types, and/or any other device characteristic. For example, a first device type, e.g., an MP3 player, may be associated with a first configuration bundle by the administrator, while a second device type, e.g., a mobile phone, may be associated with the same first configuration bundle and a second configuration bundle. Thus, in this example, each MP3 player would receive the same first configuration bundle when tethered to the host computer, while each mobile phone would receive both the first and second configuration bundles. In another example, the administrator may establish associations between target devices having certain hardware components, such as microphones, cameras, video capabilities, etc., and particular configuration bundles. For example, a configuration bundle comprising software drivers and application software for use with a camera on a mobile phone may be associated with target devices having device characteristics indicating that they are mobile phones with cameras.

In one embodiment, the administrator may also establish associations between particular target devices and configuration bundles. For example, a first subset of one or more target devices, which may be identified by UDIDs of the devices, for example, may be associated with one or more particular configuration bundles. Likewise, a second subset of one or more target devices may be associated with a different one or more configuration bundles. In one embodiment, the first subset of target devices may be each associated with users in a particular department of the administrator's entity (e.g., sales staff) and the second subset of target devices may be each associated with users in a different department of the administrator's entity (e.g., accounting staff). For example, the configuration bundle associations may indicate that for one or more specific device UDIDs (and possibly associated provisions), the host computer is to remove any provisions which are expired or otherwise invalid, add any new provisioning profiles (which have the device UDID) not already on the device based on the entitlements (or other characteristics) of the now-installed provisions, and/or add specific content contained in one or more identified configuration bundles. In one embodiment, a configuration bundle may include specific user data, such as sales data, engineering data, etc., for one or more target devices.

As described above, the administrator (or other entity that establishes associations between configuration bundles, or other configuration data, and device characteristics) is provided the ability to associate configuration bundles at the individual and/or group levels, where a group may comprise specific target devices (e.g., specific UDIDs), a set of target devices sharing one or more common device characteristics (e.g., certain device types, storage capacities, OS versions, etc.), or all target devices. Thus, a particular target device may be associated with a first configuration bundle that is associated with all target devices, a second configuration bundle that is associated with a subset of target devices having a particular device characteristic, and/or a third configuration bundle that is associated with only the particular target device.

In block 504, the host computer enters a batch configuration mode in preparation for tethering of one or more target devices. In one embodiment, the host computer executes a configuration utility that, when executed, allows the host computer to communicate with multiple target devices, select appropriate configuration data for the target devices, and transmit the configuration data to the target devices. In one embodiment, the configuration utility is included in a software development kit, such as Apple's Xcode, a separate software application, such as Apple's Phone Booth, and/or any other software application.

Moving to block 506, target devices are concurrently and/or sequentially tethered to the host computer. As noted above, tethering may be either direct or indirect, and may be via one or more wired and/or wireless communication links. In one embodiment, multiple target devices may be concurrently tethered to the host computer via a multi-device docking station.

Next, in block 508, for each respective device that tethers with the host computer, the host computer determines the appropriate configuration data and transmits the determined configuration data to respective devices. As noted above, each target device may be associated with multiple configuration bundles that are associated with one or more device characteristics of the respective target device. Thus, the host computer accesses the associations between device characteristics and configuration bundles, such as in a configuration data structure, in order to select the appropriate configuration bundles for each respective target device.

In one embodiment, the host computer compares the device characteristics received from a tethered device characteristics with device characteristics received from the same target device during a previous tethering. In certain embodiments, changes to the device characteristics may initiate selection, or de-selection, of certain configuration bundles. For example, if it appears that a certain software application has been repeatedly transmitted to a target device and installed thereon, but the software application is always uninstalled when the target device is later tethered to the host computer, the host computer may not again select the software application for transmission to the specific target device.

According to the method of FIG. 5, users of target devices may tether their devices to the host computer at their convenience in order to receive appropriate updates for their particular target device. Additionally, the method allows an administrator to automate initial configuration, and configuration updating, of multiple target devices.

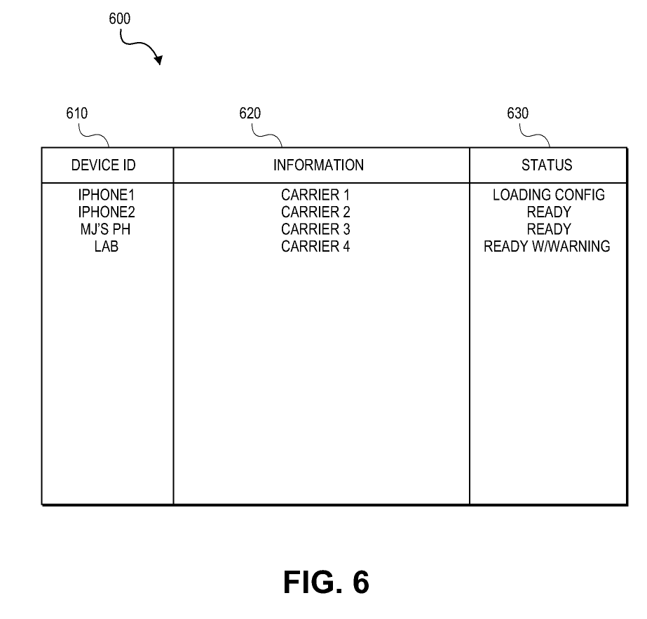

FIG. 6 illustrates exemplary user interface 600 of a configuration utility, such as configuration utility 240 of FIG. 2, that provides information regarding each of a plurality of target devices that have been tethered to a host computer. User interface 600 includes device ID column 610, device information column 620, and device status column 630. In device ID column 610, the device IDs, such as nicknames or UDIDs, for each of one or more mobile devices that are tethered to the host device are listed. In device information column 620, information regarding respective tethered devices may be listed. In the embodiment of FIG. 6, the device information column 620 indicates a wireless carrier for respective tethered devices. In other embodiments, other device characteristics associated with the tethered devices may be displayed in device information column 620 or additional similar columns. In status column 630, a status of a connection between respective devices and the host computer may be indicated. Exemplary status indicators include “loading config,” indicating that configuration data is being transferred to and/or installed on the corresponding target device, “ready,” indicating that the corresponding target device has received the determined configuration data, has completed the configuration process, and “ready with warning,” indicating that the corresponding target device has completed the configuration process, but that one or more non-critical errors occurred in the configuration process. In other embodiments, other status indicators may be used to indicate fewer or additional statuses of tethered target devices.

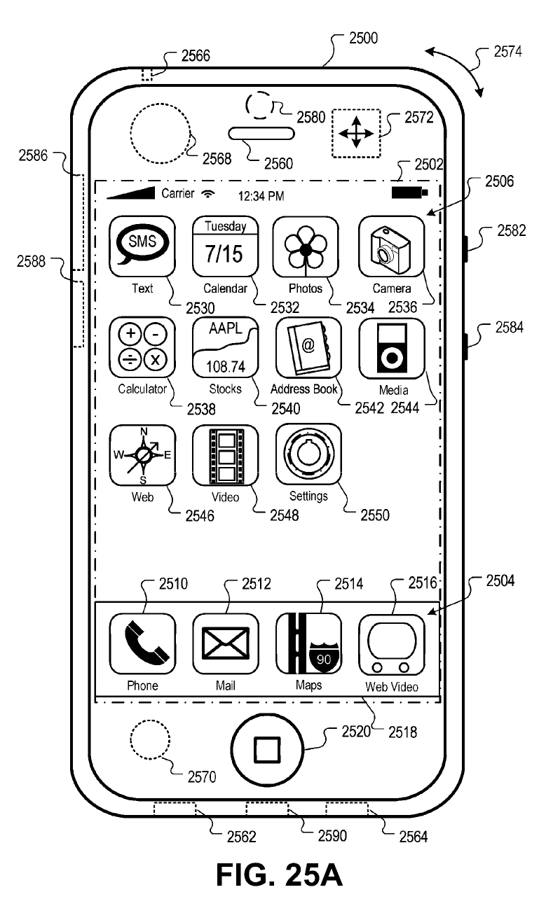

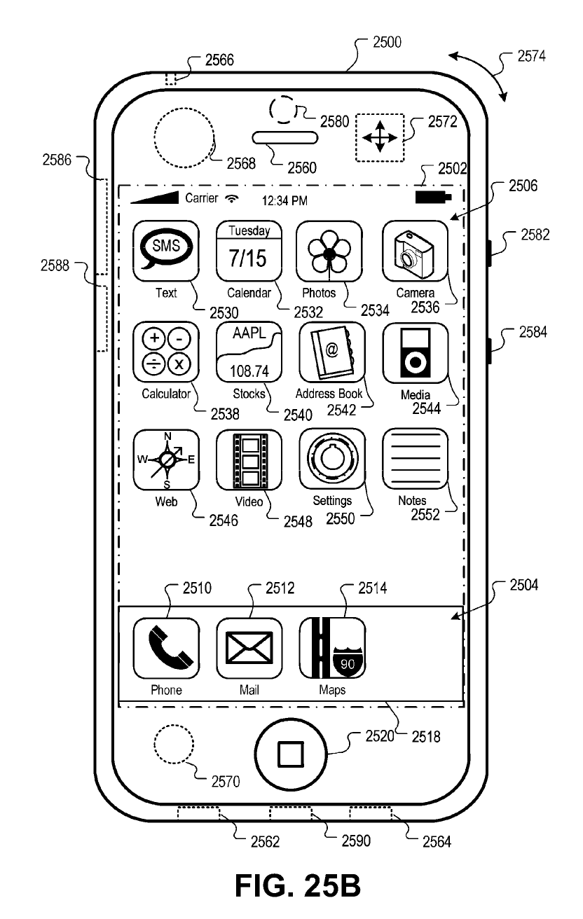

FIG. 25A illustrates an example mobile device 2500. The mobile device 2500 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or a combination of any two or more of these data processing devices or other data processing devices.

### Mobile Device Overview

In some implementations, the mobile device 2500 includes a touch-sensitive display 2502. The touch-sensitive display 2502 can be implemented with liquid crystal display (LCD) technology, light emitting polymer display (LPD) technology, or some other display technology. The touch-sensitive display 2502 can be sensitive to haptic and/or tactile contact with a user.

In some implementations, the touch-sensitive display 2502 can include a multi-touch-sensitive display 2502. A multi-touch-sensitive display 2502 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and 6,888,536, each of which is incorporated by reference herein in its entirety.

In some implementations, the mobile device 2500 can display one or more graphical user interfaces on the touch-sensitive display 2502 for providing the user access to various system objects and for conveying information to the user. In some implementations, the graphical user interface can include one or more display objects 2504, 2506. In the example shown, the display objects 2504, 2506, are graphic representations of system objects. Some examples of system objects include device functions, applications, windows, files, alerts, events, or other identifiable system objects.

### Example Mobile Device Functionalty

In some implementations, the mobile device 2500 can implement multiple device functionalities, such as a telephony device, as indicated by a Phone object 2510; an e-mail device, as indicated by the Mail object 2512; a map devices, as indicated by the Maps object 2514; a Wi-Fi base station device (not shown); and a network video transmission and display device, as indicated by the Web Video object 2516. In some implementations, particular display objects 2504, e.g., the Phone object 2510, the Mail object 2512, the Maps object 2514, and the Web Video object 2516, can be displayed in a menu bar 2518. In some implementations, device functionalities can be accessed from a top-level graphical user interface, such as the graphical user interface illustrated in FIG. 25A. Touching one of the objects 2510, 2512, 2514, or 2516 can, for example, invoke a corresponding functionality.

In some implementations, the mobile device 2500 can implement a network distribution functionality. For example, the functionality can enable the user to take the mobile device 2500 and provide access to its associated network while traveling. In particular, the mobile device 2500 can extend Internet access (e.g., Wi-Fi) to other wireless devices in the vicinity. For example, mobile device 2500 can be configured as a base station for one or more devices. As such, mobile device 2500 can grant or deny network access to other wireless devices.

In some implementations, upon invocation of a device functionality, the graphical user interface of the mobile device 2500 changes, or is augmented or replaced with another user interface or user interface elements, to facilitate user access to particular functions associated with the corresponding device functionality. For example, in response to a user touching the Phone object 2510, the graphical user interface of the touch-sensitive display 2502 may present display objects related to various phone functions; likewise, touching of the Mail object 2512 may cause the graphical user interface to present display objects related to various e-mail functions; touching the Maps object 2514 may cause the graphical user interface to present display objects related to various maps functions; and touching the Web Video object 2516 may cause the graphical user interface to present display objects related to various web video functions.

In some implementations, the top-level graphical user interface environment or state of FIG. 25A can be restored by pressing a button 2520 located near the bottom of the mobile device 2500. In some implementations, each corresponding device functionality may have corresponding “home” display objects displayed on the touch-sensitive display 2502, and the graphical user interface environment of FIG. 25A can be restored by pressing the “home” display object.

In some implementations, the top-level graphical user interface can include additional display objects 2506, such as a short messaging service (SMS) object 2530, a Calendar object 2532, a Photos object 2534, a Camera object 2536, a Calculator object 2538, a Stocks object 2540, a Address Book object 2542, a Media object 2544, a Web object 2546, a Video object 2548, a Settings object 2550, and a Notes object (not shown). Touching the SMS display object 2530 can, for example, invoke an SMS messaging environment and supporting functionality; likewise, each selection of a display object 2532, 2534, 2536, 2538, 2640, 2542, 2544, 2546, 2548, and 2550 can invoke a corresponding object environment and functionality.

Additional and/or different display objects can also be displayed in the graphical user interface of FIG. 25A. For example, if the device 2500 is functioning as a base station for other devices, one or more “connection” objects may appear in the graphical user interface to indicate the connection. In some implementations, the display objects 2506 can be configured by a user, e.g., a user may specify which display objects 2506 are displayed, and/or may download additional applications or other software that provides other functionalities and corresponding display objects.

In some implementations, the mobile device 2500 can include one or more input/output (I/O) devices and/or sensor devices. For example, a speaker 2560 and a microphone 2562 can be included to facilitate voice-enabled functionalities, such as phone and voice mail functions. In some implementations, an up/down button 2584 for volume control of the speaker 2560 and the microphone 2562 can be included. The mobile device 2500 can also include an on/off button 2582 for a ring indicator of incoming phone calls. In some implementations, a loud speaker 2564 can be included to facilitate hands-free voice functionalities, such as speaker phone functions. An audio jack 2566 can also be included for use of headphones and/or a microphone.

In some implementations, a proximity sensor 2568 can be included to facilitate the detection of the user positioning the mobile device 2500 proximate to the user's ear and, in response, to disengage the touch-sensitive display 2502 to prevent accidental function invocations. In some implementations, the touch-sensitive display 2502 can be turned off to conserve additional power when the mobile device 2500 is proximate to the user's ear.

Other sensors can also be used. For example, in some implementations, an ambient light sensor 2570 can be utilized to facilitate adjusting the brightness of the touch-sensitive display 2502. In some implementations, an accelerometer 2572 can be utilized to detect movement of the mobile device 2500, as indicated by the directional arrow 2574. Accordingly, display objects and/or media can be presented according to a detected orientation, e.g., portrait or landscape. In some implementations, the mobile device 2500 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 2500 or provided as a separate device that can be coupled to the mobile device 2500 through an interface (e.g., port device 2590) to provide access to location-based services.

In some implementations, a port device 2590, e.g., a Universal Serial Bus (USB) port, or a docking port, or some other wired port connection, can be included. The port device 2590 can, for example, be utilized to establish a wired connection to other computing devices, such as other communication devices 2500, network access devices, a personal computer, a printer, a display screen, or other processing devices capable of receiving and/or transmitting data. In some implementations, the port device 2590 allows the mobile device 2500 to synchronize with a host device using one or more protocols, such as, for example, the TCP/IP, HTTP, UDP and any other known protocol.

The mobile device 2500 can also include a camera lens and sensor 2580. In some implementations, the camera lens and sensor 2580 can be located on the back surface of the mobile device 2500. The camera can capture still images and/or video.

The mobile device 2500 can also include one or more wireless communication subsystems, such as an 802.11b/g communication device 2586, and/or a Bluetooth™ communication device 2588. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

### Example Configurable Top-Level Graphical User Interface

FIG. 25B illustrates another example of configurable top-level graphical user interface of device 2500. The device 2500 can be configured to display a different set of display objects.

In some implementations, each of one or more system objects of device 2500 has a set of system object attributes associated with it; and one of the attributes determines whether a display object for the system object will be rendered in the top-level graphical user interface. This attribute can be set by the system automatically, or by a user through certain programs or system functionalities as described below. FIG. 25B shows an example of how the Notes object 2552 (not shown in FIG. 25A) is added to and the Web Video object 2516 is removed from the top graphical user interface of device 2500 (e.g. such as when the attributes of the Notes system object and the Web Video system object are modified).

### Example Mobile Device Architecture

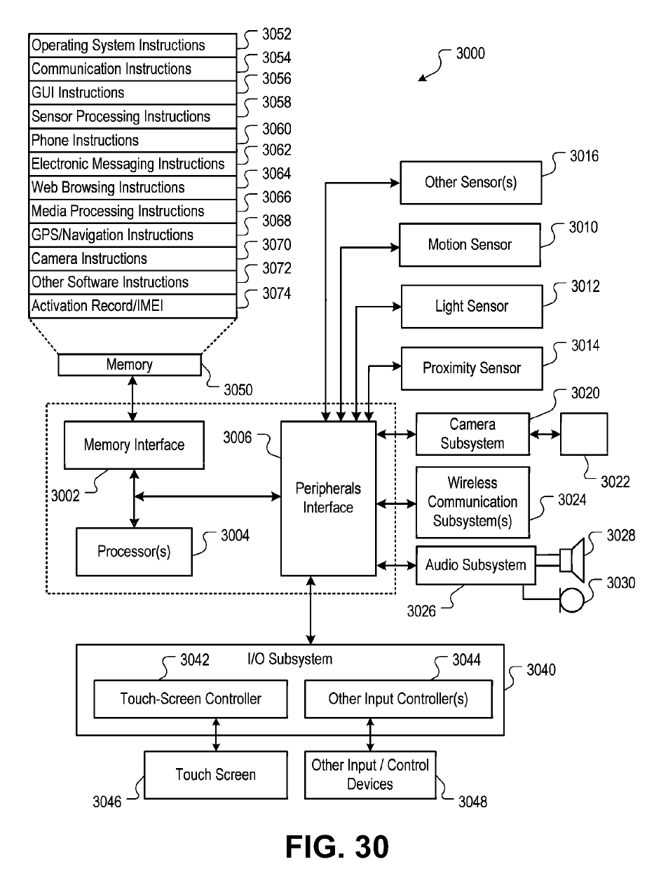

FIG. 30 is a block diagram 3000 of an example implementation of a mobile device (e.g., mobile device 2500). The mobile device can include a memory interface 3002, one or more data processors, image processors and/or central processing units 3004, and a peripherals interface 3006. The memory interface 3002, the one or more processors 3004 and/or the peripherals interface 3006 can be separate components or can be integrated in one or more integrated circuits. The various components in the mobile device can be coupled by one or more communication buses or signal lines.

Sensors, devices, and subsystems can be coupled to the peripherals interface 3006 to facilitate multiple functionalities. For example, a motion sensor 3010, a light sensor 3012, and a proximity sensor 3014 can be coupled to the peripherals interface 3006 to facilitate the orientation, lighting, and proximity functions described with respect to FIG. 25A. Other sensors 3016 can also be connected to the peripherals interface 3006, such as a positioning system (e.g., GPS receiver), a temperature sensor, a biometric sensor, or other sensing device, to facilitate related functionalities.

A camera subsystem 3020 and an optical sensor 3022, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 3024, which can include radio frequency receivers and transmitters and/or optical (e.g., infrared) receivers and transmitters. The specific design and implementation of the communication subsystem 3024 can depend on the communication network(s) over which the mobile device is intended to operate. For example, a mobile device can include communication subsystems 3024 designed to operate over a GSM network, a GPRS network, an EDGE network, a Wi-Fi or WiMax network, and a Bluetooth™ network. In particular, the wireless communication subsystems 3024 may include hosting protocols such that the mobile device may be configured as a base station for other wireless devices.

An audio subsystem 3026 can be coupled to a speaker 3028 and a microphone 3030 to facilitate voice-enabled functions, such as voice recognition, voice replication, digital recording, and telephony functions.

The I/O subsystem 3040 can include a touch screen controller 3042 and/or other input controller(s) 3044. The touch-screen controller 3042 can be coupled to a touch screen 3046. The touch screen 3046 and touch screen controller 3042 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 3046.

The other input controller(s) 3044 can be coupled to other input/control devices 3048, such as one or more buttons, rocker switches, thumb-wheel, infrared port, USB port, and/or a pointer device such as a stylus. The one or more buttons (not shown) can include an up/down button for volume control of the speaker 3028 and/or the microphone 3030.

In one implementation, a pressing of the button for a first duration may disengage a lock of the touch screen 3046; and a pressing of the button for a second duration that is longer than the first duration may turn power to the mobile device on or off. The user may be able to customize a functionality of one or more of the buttons. The touch screen 3046 can, for example, also be used to implement virtual or soft buttons and/or a keyboard.

In some implementations, the mobile device can present recorded audio and/or video files, such as MP3, AAC, and MPEG files. In some implementations, the mobile device can include the functionality of an MP3 player, such as an iPod™. The mobile device may, therefore, include a 32-pin connector that is compatible with the iPod™. Other input/output and control devices can also be used.

The memory interface 3002 can be coupled to memory 3050. The memory 3050 can include high-speed random access memory and/or non-volatile memory, such as one or more magnetic disk storage devices, one or more optical storage devices, and/or flash memory (e.g., NAND, NOR). The memory 3050 can store an operating system 3052, such as Darwin, RTXC, LINUX, UNIX, OS X, WINDOWS, or an embedded operating system such as VxWorks. The operating system 3052 may include instructions for handling basic system services and for performing hardware dependent tasks. In some implementations, the operating system 3052 can be a kernel (e.g., UNIX kernel).

The memory 3050 may also store communication instructions 3054 to facilitate communicating with one or more additional devices, one or more computers and/or one or more servers. The memory 3050 may include graphical user interface instructions 3056 to facilitate graphic user interface processing; sensor processing instructions 3058 to facilitate sensor-related processing and functions; phone instructions 3060 to facilitate phone-related processes and functions; electronic messaging instructions 3062 to facilitate electronic-messaging related processes and functions; web browsing instructions 3064 to facilitate web browsing-related processes and functions; media processing instructions 3066 to facilitate media processing-related processes and functions; GPS/Navigation instructions 3068 to facilitate GPS and navigation-related processes and instructions; camera instructions 3070 to facilitate camera-related processes and functions; and/or other software instructions 3072 to facilitate other processes and functions. The memory 3050 may also store other software instructions (not shown), such as web video instructions to facilitate web video-related processes and functions; and/or web shopping instructions to facilitate web shopping-related processes and functions. In some implementations, the media processing instructions 3066 are divided into audio processing instructions and video processing instructions to facilitate audio processing-related processes and functions and video processing-related processes and functions, respectively. An activation record and International Mobile Equipment Identity (IMEI) 3074 or similar hardware identifier can also be stored in memory 3050.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention may be indicated by the appended claims rather than by the foregoing description. All changes which come within the meaning and range of equivalency of the claims are to be embraced within their scope.

What is claimed is:

1. A method comprising:
determining first device information for a first mobile device, the first device information indicating one or more of a first device type, a first storage capacity, a first operating system version, and one or more first software applications installed on the first mobile device;
and second device information for a second mobile device, the second device information indicating one or more of a second device type, a second storage capacity, a second operating system version, and one or more second software applications installed on the second mobile device;
selecting one or more first configuration bundles associated with the first device information, wherein the one or more first configuration bundles comprise one or more first settings for configuring debugging, performance analysis, or software execution monitoring capabilities of the first mobile device when the first mobile device is later tethered to a developer computing device;
selecting one or more second configuration bundles associated with the second device information, wherein the one or more second configuration bundles comprise one or more second settings for configuring debugging, performance analysis, or software execution monitoring capabilities of the second mobile device when the second mobile device is later tethered to the developer computing device;
transmitting the one or more first configuration bundles to the first mobile device; and
transmitting the one or more second configuration bundles to the second mobile device.

2. The method of claim 1, wherein the first device information comprises a first wireless carrier of the first device and the second device information comprises a second wireless carrier of the second device.

3. The method of claim 1, wherein at least some of the device information is transmitted from the respective mobile device.

4. A method comprising:
tethering each of a plurality of mobile devices to a host computer;
receiving one or more respective device characteristics from each of the mobile devices;
determining respective configuration data for each of the tethered mobile devices, wherein the respective configuration data for each device is selected based on one or more of a device type, a specific device identifier, an operating system characteristic, and an application software characteristic; and
transmitting the determined configuration data to the respective mobile devices.

5. The method of claim 4, wherein a first group of mobile devices are associated with a first device type and a second group of mobile devices are associated with a second device type.

6. The method of claim 5, wherein the configuration data for the first group of mobile devices comprises software updates that are specific to the first device type and the configuration data for the second group of mobile devices comprises software updates that are specific to the second device type.

7. The method of claim 4, wherein the configuration data comprises one or more of data that: allows a target device to establish an appropriate development environment with a developer computing device, device settings, software for debugging, performance analysis, or software execution monitoring; indicates changes to configuration or registry settings of a target device; configures, adds, updates, or removes software; updates operating system components; personalizes or adds user interface components; and activates software available in ROM or installed over a network.

8. The method of claim 4, wherein one or more of the mobile devices are tethered to the host computer via a wireless connection.

9. The method of claim 4, wherein one or more of the mobile devices are tethered to the host computer via a physical medium.

10. The method of claim 9, wherein the physical medium comprises one or more of a uniform serial bus, an IEEE 1394 cable, and a serial cable.

11. The method of claim 4, wherein the mobile devices comprise one or more of mobile phones, audio players, and game consoles.

12. The method of claim 4, wherein at least one of the mobile devices comprises an iPhone.

13. The method of claim 4, wherein a first group of the mobile devices are each physically coupled to a device dock and the device dock is in communication with the host computer.

14. A computing system comprising:
an integrated development environment configured to interface with one or more developers in order to generate software code for mobile devices;
a batch configuration module configured to receive device information from each of a plurality of mobile devices that are tethered to the computing system, to determine configuration data for each respective mobile device, and to transmit the determined configuration data to the respective mobile devices so that each of the mobile devices are configured for communication with the integrated development environment.

15. The computing system of claim 14, wherein the integrated development environment comprises a configuration user interface configured for display on a display device, the configuration user interface providing information regarding a configuration status of each of the plurality of mobile devices.

16. The computing system of claim 15, wherein the configuration status information comprises device information, carrier information, and configuration completion information, for each of the plurality of mobile devices.

17. The computing system of claim 15, wherein the configuration user interface is configured to receive a developer input indicating one or more of the plurality of mobile devices with which the integrated development environment is currently communicating.

18. The computing system of claim 15, wherein the configuration user interface is configured to receive a developer input indicating one or more of the plurality of mobile devices with which the integrated development environment should be configured to communicate.

19. The computing system of claim 14, wherein the configuration data comprises software code for execution by a particular mobile device.

20. The computing system of claim 19, wherein the software code comprises one or more of operating system updates, application software, application software updates, registry settings, device settings, communication protocols, and user interface updates.
